(19) United States
(12) Patent Application Publication
(10) Pub. No.: US 2025/0314542 A1
(43) Pub. Date: Oct. 9, 2025

(54) METHOD FOR ASSEMBLING MAGNETOSTRICTIVE TORQUE SENSOR AND MAGNETOSTRICTIVE TORQUE SENSOR

(71) Applicants: NSK LTD., Tokyo (JP); PROTERIAL., LTD., Tokyo (JP)

(72) Inventors: Haruhiko TANNO, Takasaki-shi (JP); Kota FUKUDA, Takasaki-shi (JP); Ken OKUYAMA, Tokyo (JP); Naoki FUTAKUCHI, Tokyo (JP)

(73) Assignees: NSK LTD., Tokyo (JP); PROTERIAL., LTD., Tokyo (JP)

(21) Appl. No.: 19/097,103

(22) Filed: Apr. 1, 2025

(30) Foreign Application Priority Data
Apr. 4, 2024 (JP) 2024-060846

(51) Int. Cl. G01L 3/10

(52) U.S. Cl. CPC G01L 3/102

(57) ABSTRACT

When assembling a magnetostrictive torque sensor comprising a holder having a bobbin portion arranged around a rotating shaft to be measured, and a flexible substrate having a main body portion arranged around the bobbin portion and provided with a detection portion configured by a plurality of detection coils, a common flexible substrate having the same length in a circumferential direction of the main body portion is used when a percentage of the main body portion facing an outer circumferential surface of the rotating shaft is in a predetermined range, with a case where the main body portion of the flexible substrate faces the outer circumferential surface of the rotating shaft over an entire circumference being considered as 100%.

### TECHNICAL FIELD

The present disclosure relates to a magnetostrictive torque sensor that measures torque applied to a rotating shaft and a method for assembling thereof.

### BACKGROUND ART

As a sensor for measuring torque applied to a rotating shaft, a magnetostrictive torque sensor that measures torque applied to a rotating shaft by utilizing an inverse magnetostrictive effect that occurs in the rotating shaft when torque is applied to the rotating shaft is described in, for example, JP 2022-074405A, and has been conventionally known.

A conventional magnetostrictive torque sensor described in JP 2022-074405A includes a flexible substrate having a detection portion configured by a plurality of detection coils and arranged around a rotating shaft. The magnetostrictive torque sensor detects torque applied to the rotating shaft based on changes in inductance of the detection coils.

### CITATION LIST

### Patent Literature

Patent Literature 1: JP2022-074405A

### SUMMARY OF INVENTION

### Technical Problem

The conventional magnetostrictive torque sensor described in JP 2022-074405A is obtained by punching a base material to obtain a flexible substrate having a substantially rectangular plate-shaped main body portion provided with a detection portion, and then wrapping the main body portion around a bobbin portion (inner cylindrical portion) of a holder (first resin member) to form it into an incomplete cylindrical shape.

There are many different types of outer diameters of rotating shafts, depending on, for example, the magnitude of the torque to be transmitted, the metal material configuring the rotating shaft. Therefore, flexible substrates with different length in the circumferential direction of a main body portion, each provided with a detection portion, is prepared for each outer diameter of the rotating shaft. As a result, the number of types of flexible substrates is increased, making it difficult to reduce manufacturing costs of the magnetostrictive torque sensors.

An object of the present disclosure is to achieve a method for assembling a magnetostrictive torque sensor that makes is easier to reduce manufacturing costs.

### Solution to Problem

The inventors of the present disclosure have conducted extensive research into an effect that a percentage of a main body portion facing an outer circumferential surface of a rotating shaft gives on an accuracy of torque detection in a magnetostrictive torque sensor with a case where the main body portion of the flexible substrate faces the outer circumferential surface of the rotating shaft over the entire circumference being considered as 100%. As a result, it has been found that the accuracy of torque detection can be sufficiently ensured when the percentage is in a predetermined range. The method for assembling the magnetostrictive torque sensor of an aspect of the present disclosure and the magnetostrictive torque sensor of an aspect of the present disclosure have been completed based on these findings.

A magnetostrictive torque sensor that is a subject of a method for assembling a magnetostrictive torque sensor of an aspect of the present disclosure includes
a holder having a bobbin portion arranged around a rotating shaft to be measured, and
a flexible substrate having a main body portion arranged around the bobbin portion and provided with a detection portion configured by a plurality of detection coils.

The method for assembling the magnetostrictive torque sensor of an aspect of the present disclosure uses a common flexible substrate having a same length in a circumferential direction of the main body portion when a percentage of the main body portion facing an outer circumferential surface of the rotating shaft is in a predetermined range, with a case where the main body portion faces the outer circumferential surface of the rotating shaft over an entire circumference being considered as 100%.

In the method for assembling the magnetostrictive torque sensor of an aspect of the present disclosure, the predetermined range is in a range of 75% or more and less than 100%.

In the method for assembling the magnetostrictive torque sensor of an aspect of the present disclosure, the predetermined range is in a range of 80% or more and 90% or less.

The magnetostrictive torque sensor of an aspect of the present disclosure includes
a holder having a bobbin portion arranged around a rotating shaft, and
a flexible substrate having a main body portion arranged around the bobbin portion and provided with a detection portion configured by a plurality of detection coils.

In particular, in the magnetostrictive torque sensor of an aspect of the present disclosure, a percentage of the main body portion facing an outer circumferential surface of the rotating shaft is 75% or more and less than 92%, with a case where the main body portion faces the outer circumferential surface of the rotating shaft over an entire circumference being considered as 100%.

In the magnetostrictive torque sensor of an aspect of the present disclosure, the predetermined range is 80% or more and 90% or less.

### Effect of Invention

With the magnetostrictive torque sensor of an aspect of the present disclosure and the method for assembling thereof, it is possible to reduce manufacturing costs more easily.

### BRIEF DESCRIPTION OF DRAWINGS

FIG. 1 is a schematic view of a cross section of a magnetostrictive torque sensor of an example of an embodiment of the present disclosure, cut along an imaginary flat plane including a central axis of a rotating shaft.

FIG. 2 is a cross-sectional taken along section line X-X in FIG. 1.

FIG. 3 is a partially enlarged cross-sectional view illustrating a detection portion of a flexible substrate.

FIG. 4A through FIG. 4D are developed views of a first wiring layer through fourth wiring layer as viewed from the outside in the radial direction.

FIG. 5 schematically illustrates a detection circuit including four detection coils.

FIG. 6 is a plan view illustrating the flexible substrate in the expanded state.

### DESCRIPTION OF EMBODIMENTS

The inventors of the present disclosure have conducted extensive research into an effect that a percentage of a main body portion facing an outer circumferential surface of a rotating shaft gives on an accuracy of torque detection of the rotating shaft by a magnetostrictive torque sensor with a case where the main body portion of the flexible substrate faces the outer circumferential surface of the rotating shaft over the entire circumference being considered as 100%. As a result, it has been found that the accuracy of torque detection can be sufficiently ensured when the percentage is in a range of 75% or more and less than 100%, preferably in a range of 80% or more and 90% or less. The present disclosure has been completed based on these findings.

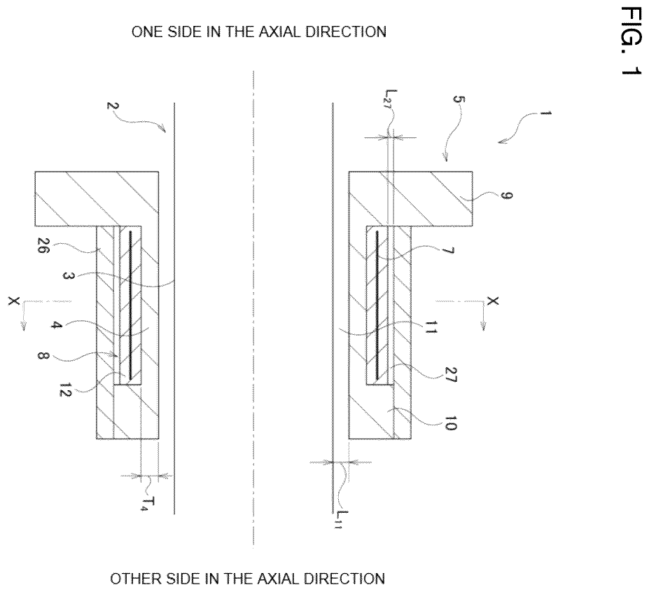

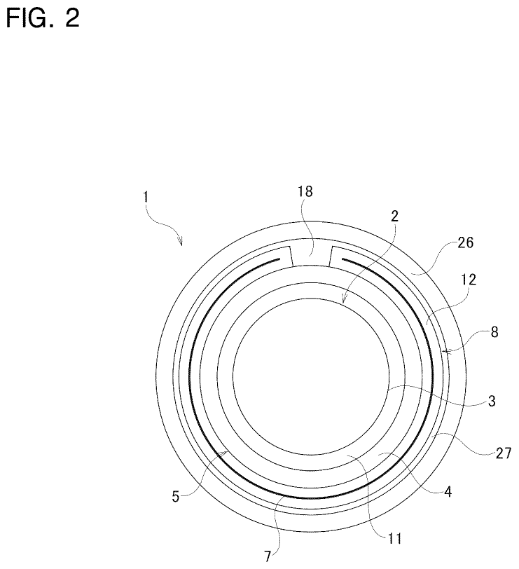

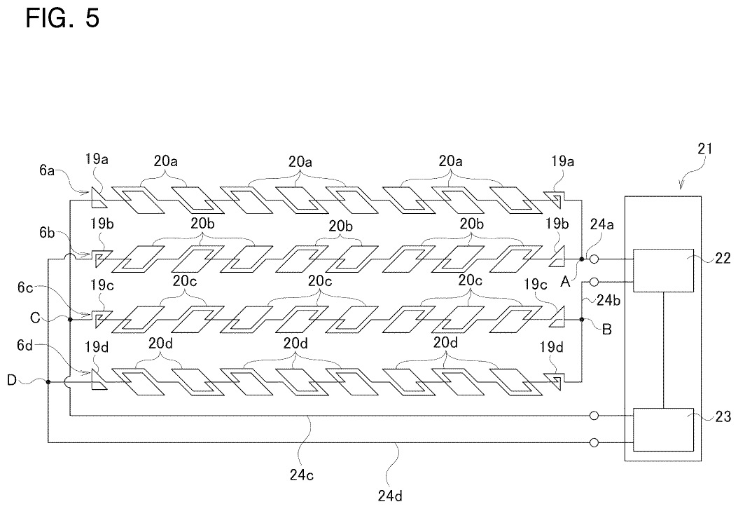

An example of an embodiment of the present disclosure will be described with reference to FIG. 1 through FIG. 6.

A magnetostrictive torque sensor 1 is used to measure torque being transmitted by a rotating shaft 2.

In the following description, the axial direction, the radial direction, and the circumferential direction of the magnetostrictive torque sensor 1 refer to the axial direction, the radial direction, and the circumferential direction of the rotating shaft 2 unless otherwise specified. The axial direction, the radial direction, and the circumferential direction of the rotating shaft 2 coincides with the axial direction, the radial direction, and the circumferential direction of a holder 5 and also coincide with the axial direction, the radial direction, and the circumferential direction of a magnetic ring 26. Further, one side in the axial direction refers to the left side in FIG. 1, and the other side in the axial direction refers to the right side in FIG. 1.

The rotating shaft 2 includes a detected portion 3, which is a cylindrical surface whose outer diameter does not change in the axial direction, on a part of an outer circumferential surface in the axial direction. The rotating shaft 2 is rotatably supported through a bearing (not illustrated) with respect to a fixed portion that does not rotate even during use.

A part including at least the detected portion 3 of or entire rotating shaft 2 is made of a material having magnetostrictive properties. Specifically, the part of or entire rotating shaft 2 may be made of a steel material such as, but not limited to, SC (carbon steel for mechanical construction), SUS (stainless steel), SCr (chromium steel), SCM (chromium molybdenum steel), or SNCM (nickel chromium molybdenum steel).

The magnetostrictive torque sensor 1 includes a holder 5 having a bobbin portion 4 arranged around the rotating shaft 2, and a flexible substrate 8 having a main body portion 12 arranged around the bobbin portion 4 and provided with a detection portion 7 configured by a plurality of detection coils 6. The magnetostrictive torque sensor 1 detects a change in magnetic permeability of the rotating shaft 2 that occurs when the rotating shaft 2 transmits torque based on an inverse magnetostrictive effect using the detection portion 7 configured by a plurality of detection coils 6, and measures the torque transmitted by the rotating shaft 2.

The holder 5 is made of synthetic resin, which is a non-magnetic and non-conductive (insulating) material. Specifically, the holder 5 is made of a thermoplastic resin such as epoxy resin, polyphenylene sulfide (PPS), PA (polyamide), or PPA (polyphthalamide). In this example, the holder 5 is integrally formed as a whole by injection molding of synthetic resin. Alternatively, the holder 5 may also be formed by combining a plurality of parts.

The holder 5 is supported and fixed to a fixed portion that does not rotate during use, such as a housing, in a state where the bobbin portion 4 is arranged around the detected portion 3 of the rotating shaft 2 so as to be coaxial with the rotating shaft 2.

In this example, the bobbin portion 4 is configured to be a cylindrical shape. That is, the bobbin portion 4 has a cylindrical surface shaped inner circumferential surface whose inner diameter does not change in the axial direction, and a cylindrical surface shaped outer circumferential surface whose outer diameter does not change in the axial direction.

Alternatively, the bobbin portion 4 may also be configured in an incomplete cylindrical shape.

The inner circumferential surface of the bobbin portion 4 faces the detected portion 3 of the rotating shaft 2 with a radial gap 11 therebetween.

In this example, the holder 5 includes, as optional elements, a first outward-facing flange portion 9 that extends from an end portion on the one side in the axial direction of the bobbin portion 4 toward the outside in the radial direction around the entire circumference, and a second outward-facing flange portion 10 that extends from an end portion on the other side in the axial direction of the bobbin portion 4 toward the outside in the radial direction around the entire circumference.

The first outward-facing flange portion 9 has, for example, a mounting portion for supporting and fixing the holder 5 to the fixed portion, and a wiring housing portion for housing cables or signal lines that electrically connect the detection coils 6a-6d to an external device.

In this example, the outer diameter of the first outward-facing flange portion 9 is larger than the outer diameter of the second outward-facing flange portion 10. However, the outer diameter of the first outward-facing flange portion 9 may be the same as the outer diameter of the second outward-facing flange portion 10, or can be smaller than the outer diameter of the second outward-facing flange portion 10.

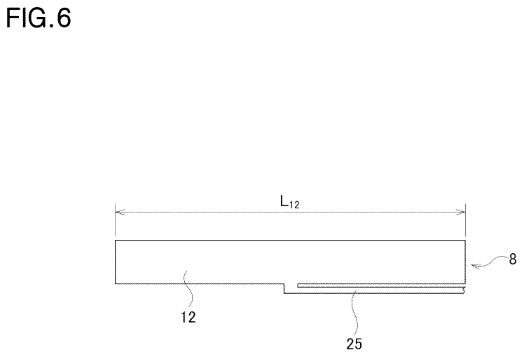

The flexible substrate 8 is configured to be elastically deformable by arranging wiring layers 13 made of a conductor on or inside base films 14 made of an insulating material. When the flexible substrate 8 is in an expanded state as illustrated in FIG. 6, the main body portion 12 provided with the detection portion 7 is configured in a belt-like or substantially rectangular plate shape. In an assembled state of the magnetostrictive torque sensor 1, the main body portion 12 is wrapped around the bobbin portion 4 of the holder 5 and formed into an incomplete cylindrical shape or cylindrical shape.

The flexible substrate 8 has a laminated structure having a plurality of wiring layers 13 that configure the detection coils 6. Each wiring layer 13 is configured by a wiring pattern formed by etching copper foil, which is a conductor.

Each wiring layer 13 is formed on a surface of the base films 14 and covered with a coverlay film 16. The coverlay films 16, the wiring layers 13, and the base films 14 are bonded together with adhesive layers 15.

The coverlay films 16 and the base films 14 are made of a thin film of an insulating material such as polyimide or polyester. The coverlay films 16 are protective films for protecting the wiring layers 13. Further, the adhesive layers 15 are made of an adhesive based on epoxy resin, acrylic resin, or polyimide resin.

The number, configuration, and arrangement of the plurality of detection coils 6 are not particularly limited as long as they are capable of detecting a change in the magnetic permeability of the rotating shaft 2. For example, the plurality of detection coils 6 may be arranged so as to overlap each other in the radial direction, or arranged side by side in the axial direction, or arranged so as to overlap each other in the radial direction and side by side in the axial direction. The number of the plurality of detection coils 6 may be any number equal to or greater than two.

The flexible substrate 8 has a number of wiring layers 13 corresponding to the number and arrangement of the detection coils 6. In this example, the flexible substrate has four detection coils 6 (first detection coil 6a to fourth detection coil 6d) and therefore has four wiring layers 13 (first wiring layer 13a to fourth wiring layer 13d).

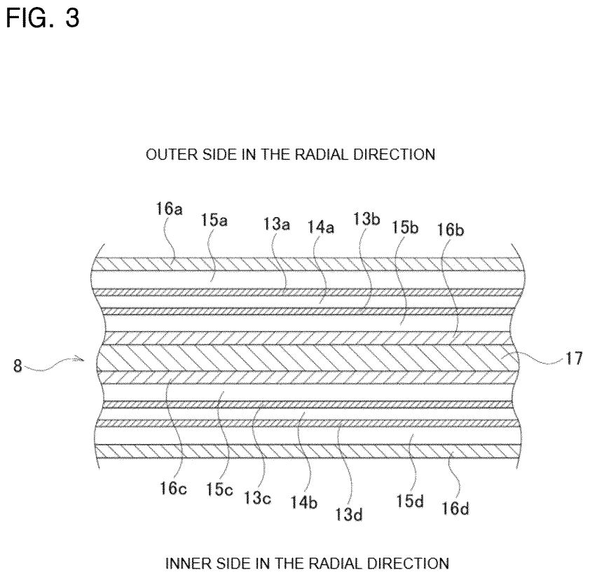

Specifically, as illustrated in FIG. 3, the flexible substrate 8 is configured by laminating, in order from the outside in the radial direction, a first coverlay film 16a, a first adhesive layer 15a, a first wiring layer 13a, a first base film 14a, a second wiring layer 13b, a second adhesive layer 15b, a second coverlay film 16b, a third adhesive layer 17, a third coverlay film 16c, a fourth adhesive layer 15c, a third wiring layer 13c, a second base film 14b, a fourth wiring layer 13d, a fifth adhesive layer 15d, a fourth coverlay film 16d.

The first wiring layer 13a is formed on a radially outer surface of the first base film 14a, and the second wiring layer 13b is formed on a radially inner surface of the first base film 14a. The third wiring layer 13c is formed on a radially outer surface of the second base film 14b, and the fourth wiring layer 13d is formed on a radially inner surface of the second base film 14b.

Each of the first adhesive layer 15a, the second adhesive layer 15b, the fourth adhesive layer 15c, and the fifth adhesive layer 15d bonds the coverlay films 16a-16d, the wiring layers 13a-13d, or the wiring layers 13a-13d and the base films 14a, 14b together. The third adhesive layer 17 bonds the two coverlay films 16 c, 16d to each other.

In this example, the first detection coil 6a is formed by the first wiring layer 13a, the second detection coil 6b is formed by the second wiring layer 13b, the third detection coil 6c is formed by the third wiring layer 13c, and the fourth detection coil 6d is formed by the fourth wiring layer 13d.

The detection portion 7 is arranged around the bobbin portion 4 and is configured by a plurality of detection coils 6.

In this example, the detection portion 7 includes four detection coils 6 (first detection coil 6a to fourth detection coil 6d), and is arranged around the bobbin portion 4 by wrapping the main body portion 12 provided with the detection portion 7 around the outer circumferential surface of the bobbin portion 4. The main body portion 12 is wrapped around the outer circumferential surface of the bobbin portion 4 so as not to detach from the outer circumferential surface of the bobbin portion 4. For this reason, the main body portion 12 can be adhesively fixed to the outer circumferential surface of the bobbin portion 4, or pressed from the outside in the radial direction by a pressing member (not illustrated).

End portions on both sides in the circumferential direction of the main body portion 12 do not overlap each other in the radial direction.

In this example, the flexible substrate 8 is used as a common component among a plurality of types of magnetostrictive torque sensors 1 used for measuring torque of a plurality of types of rotating shafts 2 having different outer diameters. Specifically, while the holder 5 and the magnetic ring 26 are designed specifically for each outer diameter of the rotating shaft 2, the flexible substrate 8 having the same length in the circumferential direction (the long dimension L₁₂ in the expanded state illustrated in FIG. 6) of the main body portion 12 is used when the outer diameter of the rotating shaft 2 is within a predetermined range. Therefore, the percentage of the main body portion 12 facing the detected portion 3 of the rotating shaft 2, when considering the entire circumference of the detected portion 3 of the rotating shaft 2 as 100%, varies depending on the outer diameter of the rotating shaft 2.

Specifically, of a plurality of types of the rotating shafts 2, for which the flexible substrate 8 having the same length in the circumferential direction of the main body portion 12 is used, in the magnetostrictive torque sensor 1 for measuring torque of a rotating shaft 2 having the smallest outer diameter, the percentage is 92% or more and less than 100%, preferably 96% or more and 98% or less. On the other hand, of a plurality of types of the rotating shafts 2, for which the flexible substrate 8 having the same length in the circumferential direction of the main body portion 12 is used, in the magnetostrictive torque sensor 1 for measuring torque of a rotating shaft 2 having the largest outer diameter, the percentage is 75% or more and 91% or less of the entire circumference, preferably 80% or more and 90% or less.

In an assembled state of the magnetostrictive torque sensor 1, it is preferable that the main body portion 12 has an incomplete cylindrical shape regardless of the outer diameter of the rotating shaft 2 to be measured. That is, of a plurality of types of the rotating shaft 2, for which the flexible substrate 8 having the same length in the circumferential direction of the main body portion 12 is used, even in the magnetostrictive torque sensor 1 for measuring torque of a rotating shaft 2 having the smallest outer diameter, it is preferable that the main body portion 12 has an incomplete cylindrical shape. In other words, in the magnetostrictive torque sensor 1 for measuring torque of a rotating shaft 2 having the smallest outer diameter, it is preferable that a circumferential gap 18 exists between the ends on both sides in the circumferential direction of the main body portion 12.

In this example, the four detection coils 6a-6d are arranged overlapping each other in the radial direction. Specifically, the four detection coils 6a-6d are arranged so as to overlap each other in the order of the first detection coil 6a, the second detection coil 6b, the third detection coil 6c, and the fourth detection coil 6d from the outside in the radial direction.

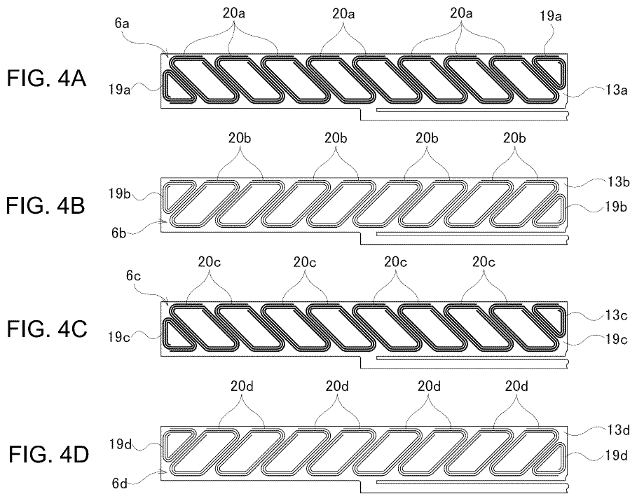

Further, as illustrated in FIG. 4A through FIG. 4D, each of the detection coils 6a-6d is formed by arranging a plurality of coil pieces 19a-19d and 20a-20d in the circumferential direction, in other words, arranging them in the long side direction of the main body portion 12 in a state before the main body portion 12 is curved into an incomplete cylindrical shape (the expanded state as illustrated in FIG. 6).

Specifically, the first detection coil 6a is configured by connecting a plurality of coil pieces 19a, 20a arranged in the circumferential direction in series, the second detection coil 6b is configured by connecting a plurality of coil pieces 19b, 20b arranged in the circumferential direction in series, the third detection coil 6c is configured by connecting a plurality of coil pieces 19c, 20c arranged in the circumferential direction in series, and the fourth detection coil 6d is configured by connecting a plurality of coil pieces 19d, 20d arranged in the circumferential direction in series.

Of the coil pieces 19a-19d and 20a-20d, the coil pieces 19a-19d arranged at the end portions on both sides in the circumferential direction are configured by arranging the wiring pattern so as to be wound in a substantially triangular shape when viewed from the radial direction, and the remaining coil pieces 20a-20d are configured by arranging the wiring pattern so as to be wound in a substantially parallelogram shape when viewed from the radial direction.

The coil pieces 19a, 20a, of the first detection coil 6a and the coil pieces 19c, 20c of the third detection coil 6c have straight portions inclined at a predetermined angle (for example, +45 degrees) in a predetermined direction relative to the axial direction of the rotating shaft 2 (the short side direction of the main body portion 12 when the flexible substrate 8 is in the expanded state). The coil pieces 19b, 20b of the second detection coil 6b and the coil pieces 19d, 20d of the fourth detection coil 6d have straight portions inclined at a predetermined angle (for example, −45 degrees) in a direction opposite to the predetermined direction relative to the axial direction of the rotating shaft 2.

The four detection coils 6a-6d are electrically connected to an external device 21.

The external device 21 includes an oscillator 22 that applies a voltage between two points, and a voltmeter 23 that detects the voltage between two points.

The manner in which the plurality of detection coils 6 are electrically connected to the external device 21 is not particularly limited, and any known means can be applied. In this example, each of the four detection coils 6a-6d and the external device 21 are electrically connected by signal lines 24a-24d formed in the wiring layers 13a-13d of the flexible substrate 8, and by the cables connected to the external device 21.

That is, the flexible substrate 8 of this example includes a belt-like signal path portion 25 (see FIG. 6) that is pulled out from the main body portion 12 in the radial direction, the axial direction, or both the radial and axial directions. The signal path portion 25 includes four-layered signal lines 24a-24d.

Of the four signal lines 24a-24d, the first signal line 24a connects an end portion on one side of the first detection coil 6a and an end portion on one side of the second detection coil 6b in series, and is electrically connected to one terminal of the oscillator 22 through the cables.

The second signal line 24b connects an end portion on one side of the third detection coil 6c and an end portion on one side of the fourth detection coil 6d in series, and is electrically connected to the other terminal of the oscillator 22 through the cables.

The third signal lines 24c connects an end portion on the other side of the first detection coil 6a and an end portion on the other side of the third detection coil 6c in series, and is electrically connected to one terminal of the voltmeter 23 through the cables.

The fourth signal line 24d connects an end portion on the other side of the second detection coil 6b and an end portion on the other side of the fourth detection coil 6d in series, and is electrically connected to the other terminal of the voltmeter 23 through the cables.

The oscillator 22 applies an AC voltage between a contact A between the end portion on the one side of the first detection coil 6a and the end portion on the one side of the second detection coil 6b, and a contact B between the end portion on the one side of the third detection coil 6c and the end portion on the one side of the fourth detection coil 6d. The voltmeter 23 detects a voltage between a contact C between the end portion on the other side of the first detection coil 6a and the end portion on the other side of the third detection coil 6c, and a contact D between the end portion on the other side of the second detection coil 6b and the end portion on the other side of the fourth detection coil 6d. That is, the four detection coils 6a-6d of the detection portion 7, together with the oscillator 22 and the voltmeter 23, form a bridge circuit.

When a torque T is applied to the rotating shaft 2, stresses σ with opposite signs (+/−) act on the outer circumferential surface of the rotating shaft 2 in a direction inclined at +45° to the axial direction and in a direction inclined at −45° to the axial direction. Due to the inverse magnetostrictive effect, the magnetic permeability increases in the direction in which a tensile stress (+σ) acts, and decreases in the direction in which the compressive stress (−σ) acts. In the magnetostrictive torque sensor 1 of this example, the voltage of the bridge circuit, which changes in accordance with the change in the magnetic permeability of the rotating shaft 2, is detected by the voltmeter 23, and the direction and magnitude of the torque transmitted by the rotating shaft 2 are determined based on this detected value.

The magnetostrictive torque sensor 1 of this example includes a magnetic ring 26 as an optional component.

The magnetic ring 26 is also called a back yoke, and has a function of suppressing leakage of magnetic flux generated in the detection coils 6a-6d to the outside. The magnetic ring 26 is integrally formed of a magnetic material as a whole. As the magnetic material configuring the magnetic ring 26, for example, an iron-based alloy such as alloy steel for machine construction or stainless steel can be used.

The magnetic ring 26 has a cylindrical shape. The magnetic ring 26 is arranged around the main body portion 12 (detection portion 7) of the flexible substrate 8 so as to be coaxial with the main body portion 12, and is attached and fixed to the holder 5. In this example, an end portion on the other side in the axial direction of the magnetic ring 26 is externally fitted and fixed to the second outward-facing flange portion 10, thereby attaching and fixing the magnetic ring 26 to the holder 5.

The method for assembling the magnetostrictive torque sensor 1 of this example can be widely applied to magnetostrictive torque sensors 1 that include a holder 5 having a bobbin portion 4 that is arranged around the rotating shaft to be measured, and a flexible substrate 8 that is arranged around the bobbin portion 4 and has a main body portion 12 provided with a detection portion 7 configured by a plurality of detection coils 6. Although the method for assembling the magnetostrictive torque sensor 1 of this example is not limited to this, the method will be described with reference to the magnetostrictive torque sensor 1 of this example having the configuration as described above.

In the method for assembling the magnetostrictive torque sensor 1, a common flexible substrate 8 having the same length in the circumferential direction of the main body portion 12 is used when the percentage of the main body portion 12 facing the outer circumferential surface of the rotating shaft 2 is in a predetermined range, with the case where the main body portion 12 of the flexible substrate 8 faces the outer circumferential surface of the rotating shaft 2 (detected portion 3) over the entire circumference being considered as 100%.

In this example, when the percentage is in the range of 75% or more and less than 100%, preferably in the range of 80% or more and 90% or less, a common flexible substrate 8 having the same length in the circumferential direction of the main body portion 12 is used.

The method for assembling the magnetostrictive torque sensor 1 of this example includes a bending step in which, of the flexible substrate 8 as illustrated in the expanded state in FIG. 6, the belt-like or substantially rectangular plate shaped main body portion 12 provided with the detection portion 7 is wrapped around the bobbin portion 4 to form it into an incomplete cylindrical shape or cylindrical shape.

As preparation for carrying out the bending process, first, a plurality of types of holder 5 with different inner and outer diameters for the bobbin portion 4 are prepared. The number of types of the holders 5 is less than or equal to the number of types of outer diameters of the rotating shaft 2.

In this example, the number of types of holders 5 is the same as the number of types of the outer diameters of the rotating shaft 2. That is, the holder 5 is designed specifically for each outer diameter of the rotating shaft 2, more specifically, the inner and outer diameters of the bobbin portion 4 are different for each outer diameter of the rotating shaft 2.

However, the number of types of the holders 5 may be less than the number of types of the outer diameters of the rotating shaft 2. Even in this case, the number of types of the holders 5 is greater than the number of types of flexible substrates 8.

Further, a plurality of types of the flexible substrates 8 having different length in the circumferential direction of the main body portion 12 (the long side dimension L₁₂ in the expanded state as illustrated in FIG. 6) are prepared. The number of types of the flexible substrates 8 is less than the number of types of the outer diameters of the rotating shaft 2 and less than the number of types of the holders 5.

In this example, two or more types of the flexible substrates 8 are prepared so that the percentage falls within the range of 75% or more and less than 100%, preferably in the range of 80% or more and 90% or less, within the range of the outer diameter of the rotating shaft 2 that can be measured.

Furthermore, in this example, a plurality of types of magnetic rings 26, which are optional components, with different inner diameters are prepared. The number of types of the magnetic rings 26 is equal to or less than the number of types of the outer diameters of the rotating shaft 2.

In this example, the number of types of the magnetic rings 26 is the same as the number of types of the outer diameters of the rotating shaft 2. That is, the number of types of the magnetic rings 26 is the same as the number of types of the holders 5.

However, the number of types of the magnetic rings 26 may be less than the number of types of the outer diameters of the rotating shaft 2. In this case, the number of types of the magnetic rings 26 may be the same as the number of types of the holders 5, or may be less than or greater than the number of types of the holders 5.

Next, a holder 5 having a bobbin portion 4 with optimal outer and inner diameters is selected from among a plurality of types of the holders 5 in accordance with the outer diameter of the rotating shaft 2 to be measured. In this example, a holder 5 specifically designed to match the outer diameter of the rotating shaft 2 to be measured is selected from among a plurality of types of holders 5.

Further, a flexible substrate 8 in which the percentage falls within the predetermined range is selected from among a plurality of types of the flexible substrates 8 in accordance with the outer diameter of the rotating shaft 2 to be measured. In this example, a flexible substrate 8 in which the percentage is 75% or more and less than 100%, preferably in the range of 80% or more and 90% or less, is selected from among a plurality of types of the flexible substrates 8. More specifically, a flexible substrate 8 is selected from among the plurality of types of the flexible substrates 8 prepared, such that when the main body portion 12 is wrapped around the selected bobbin portion 4 of the holder 5 and formed into an incomplete cylindrical shape or cylindrical shape, the distance between the end portions in the circumferential direction of the main body portion 12 is greater than 0 mm and is the smallest.

Furthermore, in this example, the magnetic ring 26 having an optimal inner diameter is selected from a plurality of types of the magnetic rings 26 in accordance with the outer diameter of the rotating shaft 2 to be measured. In this example, a magnetic ring 26 specifically designed to match the outer diameter of the rotating shaft 2 to be measured is selected from among a plurality of types of the magnetic rings 26.

Next, the selected holder 5, the flexible substrate 8, and the magnetic ring 26 are combined.

To this end, first, of the flexible substrate 8, the main body portion 12 provided with the detection portion 7 is wrapped around the bobbin portion 4 of the holder 5 to perform the bending step to form the main body portion 12 into an incomplete cylindrical shape or cylindrical shape.

In order to prevent the main body portion 12 from detaching from the bobbin portion 4, it may be adhesively fixed to the outer circumferential surface of the bobbin portion 4, or pressed from the outside in the radial direction by a pressing member (not illustrated) as needed.

Further, the signal path portion 25 of the flexible substrate 8 is pulled out in the axial direction or radial direction from the holder 5 through the wiring housing portion provided in the holder 5.

Next, the magnetic ring 26 is attached and fixed to the holder 5 in a state in which the magnetic ring 26 is arranged around the main body portion 12 so as to be coaxial with the main body portion 12. Specifically, an end portion on the other side in the axial direction of the magnetic ring 26 is externally fitted and fixed to the second outward-facing flange portion 10, and thereby the magnetic ring 26 is attached and fixed to the holder 5.

In this example, the magnetostrictive torque sensor 1 is assembled as described above.

With the magnetostrictive torque sensor 1 of this example and the method for assembling thereof, it becomes easier to reduce manufacturing costs of the magnetostrictive torque sensor 1. The reasons for this will be described below.

In this example, a common flexible substrate 8 having the same length in the circumferential direction of the main body portion 12 is used when the percentage of the main body portion 12 facing the outer circumferential surface of the rotating shaft 2 is in a predetermined range, with the case where the main body portion 12 of the flexible substrate 8 faces the outer circumferential surface of the rotating shaft 2 (detected portion 3) over the entire circumference being considered as 100%. For this reason, a flexible substrate 8 in which the percentage falls within a predetermined range is selected from among a plurality of types of the flexible substrates 8 in accordance with the outer diameter of the rotating shaft 2 to be measured. More specifically, a flexible substrate 8 in which the percentage is 75% or more and less than 100%, preferably 80% or more and 90% or less, is selected from among a plurality of types of the flexible substrates 8. Therefore, the number of types of the flexible substrates 8 is smaller than the number of types of outer diameters of the rotating shaft 2 that can be measured. Therefore, in the magnetostrictive torque sensor 1 of this example and the method for assembling thereof, compared to a conventional case in which a plurality of types of flexible substrates with different lengths in the circumferential direction of the main body portion are prepared for each outer diameter of the rotating shaft, the number of types of the flexible substrates 8 that need to be prepared can be reduced, thereby making it easier to reduce manufacturing costs.

Conventionally, flexible substrates having a substantially rectangular plate-shaped main body portion provided with a detection portion have been designed specifically and used for each outer diameter of a rotating shaft. In this way, when using a flexible substrate that is specifically designed for each outer diameter of the rotating shaft, the percentage of the main body portion facing the outer circumferential surface of the rotating shaft is 92% or more and 98% or less, with the case where the main body portion of the flexible substrate faces the outer circumferential surface of the rotating shaft over the entire circumference being considered as 100%.

On the other hand, in this example, the percentage of the main body portion 12 facing the outer circumferential surface of the rotating shaft 2 is 75% or more and less than 100%, preferably in the range of 80% or more and 90% or less, with the case where the main body portion 12 faces the outer circumferential surface of the rotating shaft 2 (detected portion 3) over the entire circumference being considered as 100%. Therefore, when the flexible substrate 8 is applied to a magnetostrictive torque sensor 1 having a torque of a rotating shaft 2 having an outer diameter other than the optimal outer diameter for applying the flexible substrate 8, the percentage is 75% or more and less than 92%, preferably 80% or more and 90% or less, or greater than 98% and less than 100%.

### REFERENCE SIGNS LIST

1 Magnetostrictive torque sensor
2 Rotating shaft
3 Detected portion
4 Bobbin portion
5 Holder
6 Detection coils
6a First detection coil
6b Second detection coil
6c Third detection coil
6d Fourth detection coil
7 Detection portion
8 Flexible substrate
9 First outward-facing flange portion
10 Second outward-facing flange portion
11 Radial gap
12 Main body portion
13 Wiring layers
13a First wiring layer
13b Second wiring layer
13c Third wiring layer
13d Fourth wiring layer
14 Base films
14a First base film
14b Second base film
15 Adhesive layers
15a First adhesive layer
15b Second adhesive layer
15c Fourth adhesive layer
15d Fifth adhesive layer
16 Coverlay film
16a First coverlay film
16b Second coverlay film
16c Third coverlay film
16d Fourth coverlay film
17 Third adhesive layer
18 Circumferential gap
19a-19d Coil pieces
20a-20d Coil pieces
21 External device
22 Oscillator
23 Voltmeter
24a-24d Signal lines
25 Signal path portion
26 Magnetic ring
27 Radial gap

1. A method for assembling a magnetostrictive torque sensor, the magnetostrictive torque sensor comprises:
a holder having a bobbin portion arranged around a rotating shaft to be measured, and
a flexible substrate having a main body portion arranged around the bobbin portion and provided with a detection portion configured by a plurality of detection coils,
the method using
a common flexible substrate having a same length in a circumferential direction of the main body portion when a percentage of the main body portion facing an outer circumferential surface of the rotating shaft is in a predetermined range, with a case where the main body portion faces the outer circumferential surface of the rotating shaft over an entire circumference being considered as 100%.

2. The method for assembling the magnetostrictive torque sensor according to claim 1, wherein the predetermined range is in a range of 75% or more and less than 100%.

3. A magnetostrictive torque sensor, comprising:
a holder having a bobbin portion arranged around a rotating shaft, and
a flexible substrate having a main body portion arranged around the bobbin portion and provided with a detection portion configured by a plurality of detection coils, wherein
a percentage of the detection portion facing an outer circumferential surface of the rotating shaft is 75% or more and less than 92%, with a case where the detection portion faces the outer circumferential surface of the rotating shaft over an entire circumference being considered as 100%.
